(19) United States
(12) Patent Application Publication
(10) Pub. No.: US 2025/0368552 A1
(43) Pub. Date: Dec. 4, 2025

(54) INHIBITION OF BIOFILMS GROWTH IN PROCESS WATERS WITH MICROBIAL INTERACTIVE COMPOSITIONS

(71) Applicant: ECOLAB USA INC., Saint Paul, MN (US)

(72) Inventors: Kun Xiong, Naperville, IL (US); Xiaojin Harry Li, Bartlett, IL (US)

(21) Appl. No.: 19/220,826

(22) Filed: May 28, 2025

Related U.S. Application Data
(60) Provisional application No. 63/655,721, filed on Jun. 4, 2024.

(51) Int. Cl. C02F 1/50; A01N 31/02

(52) U.S. Cl. CPC C02F 1/50; A01N 31/02; C02F 2303/20

(57) ABSTRACT

Methods for preventing biofilm formation in a process water systems are disclosed. The methods include treating a process water contaminated with microbial populations in a planktonic stage with a microbial interactive composition that includes a synergistic combination of a polyoxypropylene-polyoxyethylene block copolymer and an alkoxylated fatty alcohol to form a treated process water to then reduce or inhibit biofilm formation.

### CROSS-REFERENCE TO RELATED APPLICATION

This application claims priority under 35 U.S.C. § 119 to Provisional Application U.S. Ser. No. 63/655,721, filed on Jun. 4, 2024, which is herein incorporated by reference in its entirety including without limitation, the specification, claims, and abstract, as well as any figures, tables, or examples thereof.

### TECHNICAL FIELD

The disclosure relates generally to methods for preventing biofilm formation in a process water systems. The methods include treating a process water contaminated with microbial populations in a planktonic stage with a microbial interactive composition to form a treated process water to then reduce or inhibit biofilm formation. The microbial interactive compositions can include a synergistic combination of a polyoxypropylene-polyoxyethylene block copolymer and an alkoxylated fatty alcohol.

### BACKGROUND

Microorganisms in aqueous or water processing systems intend to grow on solid surfaces forming biofilms as a strategy to protect themselves from environmental challenges, including external toxic factors. The deposition of microorganisms, often referred to as biodeposits and biofouling, and biofilm formation are a naturally occurring phenomenon. The microorganisms once attached to inert surfaces form aggregates with a complex matrix consisting of extracellular polymeric substances (EPS) and this consortium of attached microorganisms is referred to as a biofilm.

These biofilms present a challenge due to the microorganisms' development of protective structures that prevent the efficacy of disinfectant chemistries. The structure of biofilms achieves this for example by producing thick masses of cells and extracellular materials. The result are biofilm structures that are a microbial community that can attach tightly to various surfaces and present significant challenges for their removal as the microorganisms within the structures can become resistant to disinfectants through various mechanisms. Research has shown that bacteria within biofilms are up to 1,000 times more resistant to antimicrobials than the same bacteria in suspension.

Once the biofilms form, the treatment effectiveness of biomanaging programs decreases. Various chemistries are used to reduce and/or remove biofilms, including for example quaternary ammonium compounds, chlorinated chemistries, and other detergent compositions. These treatments can be problematic in the sense that biocidal compositions can present environmental and regulatory challenges. There is an ongoing need for enhanced chemistries and methods for controlling biofilms in various applications, including process waters, that are less toxic or “greener” biocontrol products and programs.

Therefore, there remain challenges to the reduction and removal of biofilms, including the reduction of viable bacteria within a biofilm. Thus, there remains a need in the art for methods for effectively preventing biofilm formation to obviate the challenges in biofilm removal. There further remains a need in the art that reduces biofilm formation and therefore reduces the usage of quaternary ammonium compounds, chlorinated chemistries, and other detergent compositions required for effective removal thereof.

It is therefore an object of this disclosure to provide microbial interactive compositions with cellular interactive chemistries to surrounding the bacterial populations that pose potentials of forming biofilm to maintain the bacterial populations in planktonic stage instead of sessile stage to thereby enhance the efficiency of a biocontrol program, including use of a biocide.

It is a further object of the disclosure to provide microbial interactive compositions that are non-toxic or less toxic to mammals and the environment, to provide safety benefits.

It is another object of this disclosure to provide microbial interactive compositions that reduce the require of biocides in the biocontrol programs.

It is another object of this disclosure to provide methods of preventing biofilm formation in a process water system using these microbial interactive compositions.

Other objects, embodiments and advantages of this disclosure will be apparent to one skilled in the art in view of the following disclosure, the drawings, and the appended claims.

### SUMMARY

It is a primary object, feature, and/or advantage of the present disclosure to improve on or overcome the deficiencies in the art with respect to preventing biofilm formation in a process water system.

According to some aspects of the present disclosure, methods for preventing biofilm formation in a process water system comprise: contacting a process water contaminated with microbial populations in a planktonic stage and in need of biofilm prevention with an effective amount from about 1 ppm to about 1000 ppm of a microbial interactive composition to form a treated process water, wherein the microbial interactive composition comprises a combination of a polyoxypropylene-polyoxyethylene block copolymer and an alkoxylated fatty alcohol; maintaining the microbial population in the planktonic stage in the treated process water and reducing or inhibiting biofilm formation in the process water system.

These and/or other objects, features, advantages, aspects, and/or embodiments will become apparent to those skilled in the art after reviewing the following brief and detailed descriptions of the drawings. Furthermore, the present disclosure encompasses aspects and/or embodiments not expressly disclosed but which can be understood from a reading of the present disclosure, including at least: (a) combinations of disclosed aspects and/or embodiments and/or (b) reasonable modifications not shown or described.

While multiple embodiments are disclosed, still other embodiments will become apparent to those skilled in the art from the following detailed description, which shows and describes illustrative embodiments. Accordingly, the drawings

### BRIEF DESCRIPTION OF THE FIGURES

FIG. 1 shows the accumulation of biofilm buildup on the y axis in the presence of various concentrations of Chemicals or a Control charted against varying concentrations of the evaluated chemistries (Control: no treatment, Chemical A, Chemical B, Chemical C, and a combination of Chemicals A and C) as described in Example.

FIG. 2 shows the accumulation of a biofilm build up on the y axis in the presence of increasing concentrations of either Chemicals or a Control charted against varying concentrations of the evaluated chemistries (Control: no treatment, Chemical B, and a combination of Chemical B and Chemical A) as described in Example.

Various embodiments of the present disclosure will be described in detail with reference to the drawings, wherein like reference numerals represent like parts throughout the several views. Reference to various embodiments does not limit the scope of the disclosure. Figures represented herein are not limitations to the various embodiments according to the disclosure and are presented for exemplary illustration of the invention. An artisan of ordinary skill in the art need not view, within isolated figure(s), the near infinite number of distinct permutations of features described in the following detailed description to facilitate an understanding of the present invention.

### DETAILED DESCRIPTION

The present disclosure is not to be limited to that described herein, which can vary and are understood by skilled artisans. No features shown or described are essential to permit basic operation of the present disclosure unless otherwise indicated. It has been surprisingly found that preventing biofilm formation in a process water system is achieved in a synergistic manner using a microbial interactive composition as described herein.

It is further to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range.

All publications, including all patents, patent applications and other patent and non-patent publications cited or mentioned herein are incorporated herein by reference for at least the purposes that they are cited; including for example, for the disclosure or descriptions of methods of materials which may be used. Nothing herein is to be construed as an admission that a publication or other reference (including any reference cited in the Background section) is prior art to the invention or that the invention is not entitled to antedate such disclosure, for example, by virtue of prior invention.

As used herein, the term “and/or”, e.g., “X and/or Y” shall be understood to mean either “X and Y” or “X or Y” and shall be taken to provide explicit support for both meanings or for either meaning, e.g. A and/or B includes the options i) A, ii) B or iii) A and B.

It is to be appreciated that certain features that are, for clarity, described herein in the context of separate embodiments, may also be provided in combination in a single embodiment. Conversely, various features that are, for brevity, described in the context of a single embodiment, may also be provided separately or in any sub-combination.

The methods and compositions of the present disclosure may comprise, consist essentially of, or consist of the components and ingredients of the present disclosure as well as other ingredients described herein. As used herein, “consisting essentially of” means that the methods, systems, apparatuses and compositions may include additional steps, components or ingredients, but only if the additional steps, components or ingredients do not materially alter the basic and novel characteristics of the claimed methods, systems, apparatuses, and compositions.

Unless defined otherwise, all technical and scientific terms used above have the same meaning as commonly understood by one of ordinary skill in the art to which embodiments of the present disclosure pertain.

The terms “invention” or “present invention” are not intended to refer to any single embodiment of the particular invention but encompass all possible embodiments as described in the specification and the claims.

The term “about,” as used herein, refers to variation in the numerical quantity that can occur, for example, through typical measuring techniques and equipment, with respect to any quantifiable variable, including, but not limited to, concentration, mass, volume, time, log reduction, biofilm prevention, reduction in chemical dosing, molecular weight, temperature, pH, humidity, molar ratios, log count of bacteria, and the like. Further, given solid and liquid handling procedures used in the real world, there is certain inadvertent error and variation that is likely through differences in the manufacture, source, or purity of the ingredients used to make the compositions or carry out the methods and the like. The term “about” also encompasses these variations. Whether or not modified by the term “about,” the claims include equivalents to the quantities.

The term “actives” or “percent actives” or “percent by weight actives” or “actives concentration” are used interchangeably herein and refers to the concentration of those ingredients involved in cleaning expressed as a percentage minus inert ingredients such as water or salts. It is also sometimes indicated by a percentage in parentheses, for example, “chemical (10%).”

As used herein, the term “alkyl” or “alkyl groups” refers to saturated hydrocarbons having one or more carbon atoms, including straight-chain alkyl groups (e.g., methyl, ethyl, propyl, butyl, pentyl, hexyl, heptyl, octyl, nonyl, decyl, etc.), cyclic alkyl groups (or “cycloalkyl” or “alicyclic” or “carbocyclic” groups) (e.g., cyclopropyl, cyclopentyl, cyclohexyl, cycloheptyl, cyclooctyl, etc.), branched-chain alkyl groups (e.g., isopropyl, tert-butyl, sec-butyl, isobutyl, etc.), and alkyl-substituted alkyl groups (e.g., alkyl-substituted cycloalkyl groups and cycloalkyl-substituted alkyl groups). Unless otherwise specified, the term “alkyl” includes both “unsubstituted alkyls” and “substituted alkyls.” As used herein, the term “substituted alkyls” refers to alkyl groups having substituents replacing one or more hydrogens on one or more carbons of the hydrocarbon backbone. Such substituents may include, for example, alkenyl, alkynyl, halogeno, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), imino, sulfhydryl, alkylthio, arylthio, thiocarboxylate, sulfates, alkylsulfinyl, sulfonates, sulfamoyl, sulfonamido, nitro, trifluoromethyl, cyano, azido, heterocyclic, alkylaryl, or aromatic (including heteroaromatic) groups.

In some embodiments, substituted alkyls can include a heterocyclic group. As used herein, the term “heterocyclic group” includes closed ring structures analogous to carbocyclic groups in which one or more of the carbon atoms in the ring is an element other than carbon, for example, nitrogen, sulfur or oxygen. Heterocyclic groups may be saturated or unsaturated. Exemplary heterocyclic groups include, but are not limited to, aziridine, ethylene oxide (epoxides, oxiranes), thiirane (episulfides), dioxirane, azetidine, oxetane, thietane, dioxetane, dithietane, dithiete, azolidine, pyrrolidine, pyrroline, oxolane, dihydrofuran, and furan.

As used herein, the term “antimicrobial” refers to a compound or composition that reduces and/or inactivates a microbial population, including, but not limited to bacteria, viruses, fungi, and algae within about 10 minutes or less, about 8 minutes or less, about 5 minutes or less, about 3 minutes or less, about 2 minutes or less, about 1 minute or less, or about 30 seconds or less. Preferably, the term antimicrobial refers to a composition that provides at least about a 3 log, 3.5 log, 4 log, 4.5 log, or 5 log reduction of a microbial population in about 10 minutes or less, about 8 minutes or less, about 5 minutes or less, about 3 minutes or less, about 2 minutes or less, about 1 minute or less, or about 30 seconds or less.

As used herein, the term “between” is inclusive of any endpoints noted relative to a described range.

As used herein, the term “exemplary” refers to an example, an instance, or an illustration, and does not indicate a most preferred embodiment unless otherwise stated.

The term “generally” encompasses both “about” and “substantially.”

As used herein, the term “microorganism” refers to any noncellular or unicellular (including colonial) organism. Microorganisms include all prokaryotes. Microorganisms include bacteria (including cyanobacteria, anaerobic and aerobic bacteria populations), spores, lichens, fungi, protozoa, virinos, viroids, viruses, phages, and some algae. As used herein, the term “microbe” is synonymous with microorganism.

As used herein, the term “oligomer” refers to a molecular complex comprised of between one and ten monomeric units. For example, dimers, trimers, and tetramers, are considered oligomers. Furthermore, unless otherwise specifically limited, the term “oligomer” shall include all possible isomeric configurations of the molecule, including, but are not limited to isotactic, syndiotactic and random symmetries, and combinations thereof. Furthermore, unless otherwise specifically limited, the term “oligomer” shall include all possible geometrical configurations of the molecule.

As used herein the term “planktonic stage” in reference to biofilm formation refers to bacterial populations that are in free-floating status in a solution, whereas the term “sessile stage” refers to bacterial populations that are attached to a surface and forming biofilms. In reference to biofilm formation there are generally five stages as follows: (1) planktonic bacteria adhere to the biomaterial surface; (2) cells aggregate, form micro colonies and excrete extracellular polymeric substances (EPS), also referred to as slime, and the stage where the attachment is irreversible; (3) biofilm is formed and as it matures cells form multi-layered clusters; (4) three-dimensional growth and further maturation of the biofilm, providing protection against biocide treatment and environment changes; and (5) biofilm reaches a critical mass and disperses planktonic bacteria which thereafter can colonize other surfaces.

As used herein the term “polymer” refers to a molecular complex comprised of a more than ten monomeric units and generally includes, but is not limited to, homopolymers, copolymers, such as for example, block, graft, random and alternating copolymers, terpolymers, and higher “x”mers, further including their analogs, derivatives, combinations, and blends thereof. Furthermore, unless otherwise specifically limited, the term “polymer” shall include all possible isomeric configurations of the molecule, including, but are not limited to isotactic, syndiotactic and random symmetries, and combinations thereof. Furthermore, unless otherwise specifically limited, the term “polymer” shall include all possible geometrical configurations of the molecule.

As used herein, the term “reduce”, “reducing” or like terms when used with respect to a condition or material, such as a biofilm, that decreases the prevalence and presence of the condition or material, such as forming a biofilm by reducing or inhibiting the biofilm grown by least about 10% (e.g., at least about 20%, about 30%, about 40%, about 50%, about 60%, about 70%, about 80%, about 90%, about 95%, or about 100%).

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

The term “surfactant” or “surface active agent” refers to an organic chemical that when added to a liquid change the properties of that liquid at a surface.

As used herein the terms “use solution,” “ready to use,” or variations thereof refer to a composition that is diluted, for example, with water, to form a use composition having the desired components of active ingredients for cleaning. For reasons of economics, a concentrate can be marketed, and an end-user can dilute the concentrate with water or an aqueous diluent to a use solution.

The term “weight percent,” “wt-%,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt-%,” etc.

Methods for preventing biofilm formation in a process water are provided through use of microbial interactive compositions with cellular interactive chemistries. These chemistries in the microbial interactive compositions surrounding the bacterial populations that pose potentials of forming biofilm to maintain the bacterial populations in a planktonic stage instead of sessile stage to thereby enhance the efficiency of a biocontrol program, including use of a biocide. It is an aim of the methods to provide microbial interactive compositions that are non-toxic or less toxic to mammals and the environment, to provide safety benefits, compared to conventional biocide compositions.

The methods for preventing biofilm formation through the use of a microbial interactive composition are distinct from methods that coat surfaces in contact with contaminated process water. Such methods form biofilm-resistant surfaces, which are distinct from the methods described herein.

Methods for preventing biofilm formation in a process water system are provided. The methods include contacting a process water contaminated with microbial populations in a planktonic stage and in need of biofilm prevention with an effective amount of a microbial interactive composition to form a treated process water. The treated process water has the microbial interactive composition dispersed therein. The methods further include maintaining the microbial population in the planktonic stage in the treated process water and reducing or inhibiting biofilm formation in the process water system.

The microbial interactive compositions can be provided at an effective amount of at least about 1 ppm, or from about 1 ppm to about 1000 ppm. The microbial interactive compositions can be provided at an effective amount of from about 1 ppm to about 50 ppm, from about 5 ppm to about 50 ppm, from about 1 ppm to about 20 ppm, or from about 5 ppm to about 20 ppm.

The microbial interactive compositions comprise a combination of a polyoxypropylene-polyoxyethylene block copolymer and an alkoxylated fatty alcohol. In certain embodiments the microbial interactive compositions comprise a combination of a polyoxyalkylene-polyoxyethylene block copolymer and an alkoxylated fatty alcohol.

Polyoxypropylene-polyoxyethylene block copolymers suitable for use in the microbial interactive compositions have the general structure of a block copolymer or a triblock copolymer as shown, respectively:

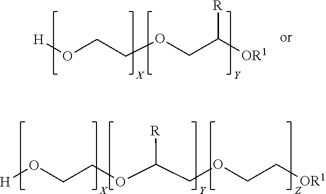

wherein: R is CH₃ (methyl) or C1-C20 group; R¹ is C1-C5 group or hydrogen; x is 5 to 100; y is 5 to 200; and z is 5 to 100.

In embodiments the polyoxypropylene-polyoxyethylene block copolymer is a triblock copolymer comprising poly(ethylene oxide) (PEO)-poly(propylene oxide) (PPO)-poly(ethylene oxide) (PEO) and having the general structure:

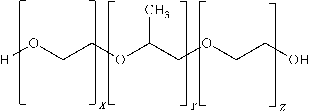

wherein x is 5 to 100; y is 5 to 200; and z is 5 to 100, wherein x is 10 to 40; y is 50 to 100; and z is 10 to 40, or wherein x is 10 to 30; y is 50 to 100; and z is 10 to 30.

Commercially available examples of the polyoxypropylene-polyoxyethylene block copolymer include, for example, Pluronic P103, Pluronic P123, which are available from Sigma-Aldrich, and Poloxamers, such as Poloxamer 407 or 188.

Alkoxylated fatty alcohols suitable for use in the microbial interactive compositions have the general structure of

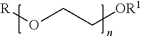

wherein R is a linear or branched, saturated or unsaturated hydrocarbon group having a carbon chain of C5-C60, C10-C30, C10-C20 or preferably C5-C20, R¹ is a C1-C5 saturated or unsaturated hydrocarbon group or hydrogen; and n is 1-100.

In further embodiments the alkoxylated fatty alcohol has R that is a C16-C18 linear or branched alkyl group and n is 10-60, 10-30, 20-30, or preferably 20-25, and R¹ is hydrogen.

Commercially available examples of the alkoxylated fatty alcohols include, for example, Brij58, Brij S20 and Emulgin® B25 from Sigma-Aldrich.

The microbial interactive compositions provide a synergist combination of the polyoxypropylene-polyoxyethylene block copolymer and an alkoxylated fatty alcohol. In embodiments, the polyoxypropylene-polyoxyethylene block copolymer and the alkoxylated fatty alcohol have a synergistic index value between about 0.3 and about 0.9 as measured by Qa/QA+Qb/QB, wherein Qa is the concentration of A in a chemical mixture of A+B, QA is the concentration of A as a single chemical, Qb is the concentration of B in a chemical mixture of A+B, and QB is the concentration of B as a single chemical.

In embodiments the synergist combination of the polyoxypropylene-polyoxyethylene block copolymer and an alkoxylated fatty alcohol are provided at a weight ratio of the polyoxypropylene-polyoxyethylene block copolymer to the alkoxylated fatty alcohol at about 1:1, or from about 3:1 to about 1:3, or from about 2:1 to about 1:2.

The microbial interactive compositions can comprise a composition, including a concentrate or a use solution, comprising from about 1 wt-% to about 20 wt-% polyoxypropylene-polyoxyethylene block copolymer and from about 0.1 wt-% to about 20 wt-% alkoxylated fatty alcohol. In addition, without being limited according to the disclosure, all ranges recited are inclusive of the numbers defining the range and include each integer within the defined range.

The microbial interactive compositions can further include or be combined at a point of use for treating a process water with one or more additional functional ingredients. Exemplary additional functional ingredients can include a carrier, a corrosion inhibitor, an additional fouling control agent, preservative, a pH modifier, a coagulant, a flocculant, a water clarifier, a dispersant, foaming agent, antifoaming agent, or mixture thereof.

In exemplary embodiments the microbial interactive compositions can further include a carrier, such as for example, water, an organic solvent or a mixture thereof.

The term “solvent” as used herein refers to any inorganic or organic solvent. Solvents are useful in the disclosed method or article, product, or composition as reaction solvent or carrier solvent. Suitable solvents include, but are not limited to, oxygenated solvents such as lower alkanols, lower alkyl ethers, glycols, aryl glycol ethers and lower alkyl glycol ethers. Examples of other solvents include, but are not limited to, methanol, ethanol, propanol, isopropanol and butanol, isobutanol, ethylene glycol, diethylene glycol, triethylene glycol, propylene glycol, dipropylene glycol, mixed ethylene-propylene glycol ethers, ethylene glycol phenyl ether, and propylene glycol phenyl ether. Water is a solvent too. The solvent used herein can be of a single solvent or a mixture of many different solvents.

The methods include contacting the process water in need of biofilm prevention with an effective amount of a microbial interactive composition to form the treated process water. In embodiments, the microbial interactive composition is provided at a concentration from about 1 ppm to about 1000 ppm, from about 1 ppm to about 50 ppm, from about 5 ppm to about 50 ppm, from about 1 ppm to about 20 ppm, or from about 5 ppm to about 20 ppm. As referred to herein the concentration refers to the polyoxypropylene-polyoxyethylene block copolymer and an alkoxylated fatty alcohol concentration in the microbial interactive composition.

The methods can include contacting the process water with the microbial interactive compositions at various flow rate of a flow line in which the composition is used can be between about 0.01 and 100 feet per second, or between 0.1 and 50 feet per second.

The methods can include contacting the process water with the microbial interactive compositions at any selected temperature, such as ambient temperature or an elevated temperature such as from about −50° C. to about 300°° C.

The methods can further include adding a biocide with the microbial interactive composition and/or contacting the treated process water with a biocide to further aid in killing the microbial populations in the planktonic stage. Biocides can include oxidizing or non-oxidizing biocides.

Oxidizing biocides include, but are not limited to, bleach, chlorine, bromine, chlorine dioxide, peroxycarboxylic acid, peroxycarboxylic acid composition, and materials capable of releasing chlorine, bromine, or a peroxide. Further listings of oxidizing biocides can include oxidizing biocides include, for example, sodium hypochlorite, trichloroisocyanuric acids, dichloroisocyanuric acid, calcium hypochlorite, lithium hypochlorite, chlorinated hydantoins, stabilized sodium hypobromite, activated sodium bromide, brominated hydantoins, chlorine dioxide, ozone or any advanced oxidative process (AOP), peroxycarboxylic acid, peroxycarboxylic acid composition, and peroxides. Advanced oxidative process (AOP) referring to a process that produces oxidative biocidal components. In an embodiment AOP includes any aid/device that producing ozone (O3), ultraviolet (UV), hydroxyl radicals, and/or oxidizing compounds (e.g. hydrogen peroxide) and/or catalyst.

Non-oxidizing biocides include, but are not limited to, aldehydes (e.g., formaldehyde, glutaraldehyde, and acrolein), amine-type compounds (e.g., quaternary amine compounds and cocodiamine), halogenated compounds (e.g., 2-bromo-2-nitropropane-3-diol (Bronopol) and 2-2-dibromo-3-nitrilopropionamide (DBNPA)), sulfur compounds (e.g., isothiazolone, carbamates, and metronidazole), quaternary phosphonium salts (e.g., tetrakis(hydroxymethyl)-phosphonium sulfate (THPS)). Additional examples include for example, glutaraldehyde, isothiazolin, 2,2-dibromo-3-nitrilopropionamide, 2-bromo-2-nitropropane-1,3 diol, 1-bromo-1-(bromomethyl)-1,3-propanedicarbonitrile, tetrachloroisophthalonitrile, alkyldimethylbenzylammonium chloride, dimethyl dialkyl ammonium chloride, didecyl dimethyl ammonium chloride, poly(oxyethylene(dimethyliminio)ethylene(dimethyliminio)ethylene dichloride, methylene bisthiocyanate, 2-decylthioethanamine, tetrakishydroxymethyl phosphonium sulfate, dithiocarbamate, cyanodithioimidocarbonate, 2-methyl-5-nitroimidazole-1-ethanol, 2-(2-bromo-2-nitroethenyl)furan, beta-bromo-beta-nitrostyrene, beta-nitrostyrene, beta-nitrovinyl furan, 2-bromo-2-bromomethyl glutaronitrile, bis(trichloromethyl) sulfone, S-(2-hydroxypropyl)thiomethanesulfonate, tetrahydro-3,5-dimethyl-2H-1,3,5-hydrazine-2-thione, 2-(thiocyanomethylthio)benzothiazole, 2-bromo-4′-hydroxyacetophenone, 1,4-bis(bromoacetoxy)-2-butene, bis(tributyltin)oxide, 2-(tert-butylamino)-4-chloro-6-(cthylamino)-s-triazine, dodecylguanidine acetate, dodecylguanidine hydrochloride, coco alkyldimethylamine oxide, n-coco alkyltrimethylenediamine, tetra-alkyl phosphonium chloride, 7-oxabicyclo[2.2. 1]heptane-2,3-dicarboxylic acid, 4,5-dichloro-2-n-octyl-4-isothiazoline-3-one, 5-chloro-2-methyl-4-isothiazolin-3-one and 2-methyl-4-isothiazolin-3-one.

Exemplary biocides suitable for use with the methods and the synergistic combination of the polyoxypropylene-polyoxyethylene block copolymer and an alkoxylated fatty alcohol in the microbial interactive composition can comprises a quaternary ammonium compound (preferably a quaternary ammonium halide), chlorine, hypochlorite, ClO₂, bromine, ozone, hydrogen peroxide, peracetic acid, peroxycarboxylic acid, peroxycarboxylic acid composition, peroxysulphate, glutaraldehyde, dibromonitrilopropionamide, isothiazolone, terbutylazine, polymeric biguanide, methylene bisthiocyanate, tetrakis hydroxymethyl phosphonium sulphate, or the like. Biocides can also be a part of an advanced oxidative process including one or more of ozone (O3), ultraviolet (UV), hydrogen peroxide, and/or catalyst.

Beneficially, the methods as described herein if including a biocide require a reduced concentration of the biocide as a result of the synergistic combination of the polyoxypropylene-polyoxyethylene block copolymer and an alkoxylated fatty alcohol in the microbial interactive composition. In embodiments the biocide concentration is reduced by at least about 50%, 75%, 80%, 90%, or more. The reduction in biocide concentration beneficially provides the equivalent biofilm prevention and/or remediation compared to a process water that is not treated with the microbial interactive composition and with the biocide alone. One skilled in the art will ascertain that a particular reduced concentration of biocide is dependent on conditions and systems of the process water.

The reduced usage of biocides, such as chlorine and/or quaternary ammonium compounds is beneficial as the methods can further comprise discharging the treated process water, and the discharged treated process water has such reduced biocide concentration.

The methods as referred to herein are suitable for use in various process waters, namely process waters that are a part of an industrial water or liquid system. Exemplary industrial water or liquid systems can include for example, cooling water systems, cooling liquid systems, open or closed loop water or liquid cooling systems, boilers and boiler water systems, flotation and benefaction systems, aqueous systems in papermaking processes, pulp and paper mill systems, paper mill digesters, water paper, washers, bleach plants, stock chests, white water systems, black liquor evaporators in the pulp industry, gas scrubbers and air washers, continuous casting processes in the metallurgical industry, air conditioning and refrigeration systems, indirect contact cooling and heating water, water reclamation systems, water purification systems, membrane filtration water systems, food and/or beverage processing systems and streams, brewery pasteurizers, sweat water systems, waste treatment systems, clarifiers, liquid-solid applications, industrial lubricant systems, heat transfer systems, municipal sewage treatment, municipal water systems, potable water systems, aquifers, water tanks, sprinkler systems, water heaters, textile process systems including for example laundry and textile care, biofouling control in process waters associated with mining, food and beverage and other industrial processes, or a combination thereof.

In embodiments, the process water is a cooling water or liquid system, such as an open recirculating water system, closed water system, once-through cooling water system, closed loop cooling system, or chip liquid cooling system or direct to chip liquid cooling system, such as those found in data centers, high-performance computing (HPC) centers, and also artificial intelligence (AI) data centers.

The methods of treating a process water includes treating a water source that is contaminated with a microbial population. Such microbial populations can be present at varying concentrations, such as at a concentration from about 10⁴-10¹⁰ CFU/mL. Such concentrations of microbial populations can include anaerobic and/or aerobic bacterial populations that are known to form biofilm within process waters and/or on surfaces in contact therewith.

Beneficially, according to the methods described herein, the methods for preventing biofilm formation in a process water system contaminated with microbial populations in a planktonic stage beneficially maintain the microbial population in the planktonic stage in the treated process water. This makes the microbial populations more readily controlled by the microbial interactive compositions. Thereafter, the treated process waters can be discharged and the microbial populations remaining in the planktonic stage are readily treated in the same system or downstream discharge facilities and water treatment processes. In such embodiments the microbial population in the planktonic stages are readily able to be managed through conventional downstream water treatment processes, such as for example those disclosed in U.S. Pat. No. 11,292,734 for water clarification processes.

In additional embodiments the treated process water contacts a surface contaminated with a biofilm and/or biofilm forming bacterial population and the microbial interactive compositions (which can include biocides) are able to further treat biofilms. In some embodiments, the surface is partially or fully submerged in the treated process water.

### EMBODIMENTS

The present disclosure is further defined by the following numbered embodiments:
1. A method for preventing biofilm formation in a process water system comprising: contacting a process water contaminated with microbial populations in a planktonic stage and in need of biofilm prevention with an effective amount from about 1 ppm to about 1000 ppm of a microbial interactive composition to form a treated process water, wherein the microbial interactive composition comprises a combination of a polyoxypropylene-polyoxyethylene block copolymer and an alkoxylated fatty alcohol; maintaining the microbial population in the planktonic stage in the treated process water and reducing or inhibiting biofilm formation in the process water system.
2. The method of paragraph 1, wherein the polyoxypropylene-polyoxyethylene block copolymer and the alkoxylated fatty alcohol have a synergistic index value between about 0.3 and about 0.9 as measured by Qa/QA+Qb/QB, wherein Qa is the concentration of A in a chemical mixture of A+B, QA is the concentration of A as a single chemical, Qb is the concentration of B in a chemical mixture of A+B, and QB is the concentration of B as a single chemical.
3. The method of any one of paragraphs 1-2, wherein the polyoxypropylene-polyoxyethylene block copolymer has the general structure of

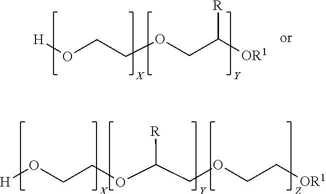

wherein: R is CH3 or C1-C20 group; R1 is C1-C5 group or hydrogen; x is 5 to 100; y is 5 to 200; and z is 5 to 100.
4. The method of paragraph 3, wherein the polyoxypropylene-polyoxyethylene block copolymer is a triblock copolymer comprising poly(ethylene oxide) (PEO)-poly(propylene oxide) (PPO)-poly(ethylene oxide) (PEO) and having the general structure

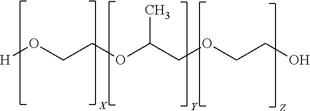

wherein x is 10 to 40; y is 50 to 100; and z is 10 to 40.
5. The method of any one of paragraphs 1-4, wherein the alkoxylated fatty alcohol has the general structure of

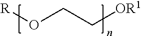

wherein R is a linear or branched, saturated or unsaturated hydrocarbon group having a carbon chain of C5-C60, C10-C20, or preferably C5-C20, R1 is a C1-C5 saturated or unsaturated hydrocarbon group or hydrogen; and n is 1-100.
6. The method of paragraph 5, wherein the alkoxylated fatty alcohol has R that is a C16-C18 linear or branched hydrocarbon group and n is 10-60, 10-30, 20-30, or preferably 20-25.
7. The method of any one of paragraphs 1-6, wherein the polyoxypropylene-polyoxyethylene block copolymer has the general structure of

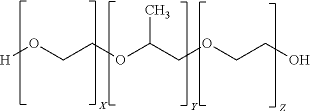

wherein x is 10 to 30; y is 50 to 100; and z is 10 to 30, and wherein the alkoxylated fatty alcohol has the general structure of

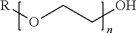

wherein R is a linear or branched, saturated or unsaturated hydrocarbon group having a carbon chain of C10-C20; and n is 20-25.
8. The method of any one of paragraphs 1-7, wherein the weight ratio of the polyoxypropylene-polyoxyethylene block copolymer to the alkoxylated fatty alcohol is about 1:1, or from about 3:1 to about 1:3.
9. The method of any one of paragraphs 1-8, wherein the microbial interactive composition further comprises at least one of a carrier, a corrosion inhibitor, an additional fouling control agent, preservative, a pH modifier, a coagulant, a flocculant, a water clarifier, a dispersant, foaming agent, antifoaming agent, or mixture thereof, and preferably wherein the carrier is water, an organic solvent or a mixture thereof.
10. The method of any one of paragraphs 1-9, wherein the microbial interactive composition comprises from about 1 wt-% to about 20 wt-% polyoxypropylene-polyoxyethylene block copolymer and from about 0.1 wt-% to about 20 wt-% alkoxylated fatty alcohol.
11. The method of any one of paragraphs 1-10, wherein the microbial interactive composition is provided in the treated process water at a concentration from about 1 ppm to about 20 ppm.
12. The method of any one of paragraphs 1-11, further comprising contacting the treated process water with a biocide to kill the microbial populations in the planktonic stage.
13. The method of paragraph 12, wherein the biocide comprises a quaternary ammonium compound (preferably a quaternary ammonium halide), chlorine, hypochlorite, ClO₂, bromine, ozone, hydrogen peroxide, peracetic acid, peroxycarboxylic acid, peroxycarboxylic acid composition, peroxysulphate, glutaraldehyde, dibromonitrilopropionamide, isothiazolone, terbutylazine, polymeric biguanide, methylene bisthiocyanate, or tetrakis hydroxymethyl phosphonium sulphate.
14. The method of any one of paragraphs 12-13, wherein a reduced concentration of biocide of at least about 50%, 75%, 80%, 90%, or more is required for biofilm prevention and/or remediation compared to a process water that is not treated with the microbial interactive composition, wherein the reduced concentration of biocide is dependent on conditions and systems of the process water.
15. The method of paragraph 14, wherein the method further comprises discharging the treated process water and wherein the discharged treated process water has reduced biocide concentration.
16. The method of any one of paragraphs 13-15, wherein the biocide is combined with an advanced oxidative process comprising one or more ozone, ultraviolet, hydrogen peroxide, and/or catalyst.
17. The method of any one of paragraphs 1-16, wherein the process water is part of an industrial water or liquid system.
18. The method of paragraph 17, wherein the industrial water or liquid system comprises cooling water systems, cooling liquid systems, open or closed loop water or liquid cooling systems, boilers and boiler water systems, flotation and benefaction systems, aqueous systems in papermaking processes, pulp and paper mill systems, paper mill digesters, washers, bleach plants, stock chests, white water systems, black liquor evaporators in the pulp industry, gas scrubbers and air washers, continuous casting processes in the metallurgical industry, air conditioning and refrigeration systems, indirect contact cooling and heating water, water reclamation systems, water purification systems, membrane filtration water systems, food and/or beverage processing systems and streams, brewery pasteurizers, sweat water systems, waste treatment systems, clarifiers, liquid-solid applications, industrial lubricant systems, heat transfer systems, municipal sewage treatment, municipal water systems, potable water systems, aquifers, water tanks, sprinkler systems, water heaters, textile process systems, or a combination thereof.
19. The method of paragraph 18, wherein the cooling water or liquid system is an open recirculating water system, closed water system, once-through cooling water system, closed loop cooling system, or direct to chip liquid cooling system.
20. The method of any one of paragraphs 1-19, wherein the microbial population is present in the process water at a concentration from about 10⁴-10¹⁰ CFU/mL.
21. The method of paragraph 20, wherein the microbial population comprises anaerobic and/or aerobic bacterial population to provide a biofilm forming bacterial population.
22. The method of any one of paragraphs 1-21, wherein the treated process water contacts a surface contaminated with a biofilm and/or biofilm forming bacterial population.
23. The method of paragraph 22, wherein the surface is partially or fully submerged in the treated process water.
24. The method of anyone of paragraphs 22 or 23, wherein the treated process water achieves microbial kill.

### EXAMPLES

Embodiments of the present disclosure are further defined in the following non-limiting Examples. It should be understood that these Examples, while indicating certain embodiments of the disclosure, are given by way of illustration only. From the above discussion and these Examples, one skilled in the art can ascertain the essential characteristics of this disclosure, and without departing from the spirit and scope thereof, can make various changes and modifications of the embodiments of the disclosure to adapt it to various usages and conditions. Thus, various modifications of the embodiments of the disclosure, in addition to those shown and described herein, will be apparent to those skilled in the art from the foregoing description. Such modifications are also intended to fall within the scope of the appended claims.

The following materials were used to conduct the trials explained in the Examples:

Alcohols (C16-C18) ethoxylated.

Pluronic P103: a methyl-oxirane polymer difunctional block copolymer surfactant terminating in primary hydroxyl group.

Pluronic P123: a poly(ethylene glycol)-block-poly(propylene glycol)-block-poly(ethylene glycol) copolymer commercially available from Sigma-Aldrich.

Polyethylene glycol hexadecyl ether and Polyoxymethylene (10) cetyl ether.

Polyoxyethylene (100) stearyl ether.

A triblock copolymer consisting of a central hydrophobic block of propylene glycol flanked by two hydrophilic blocks of polyethylene glycol.

A biocompatible block copolymer composed of repeated units of Poly(ethylene oxide) and poly(propylene oxide) PPO may be used.

The bacterial species used for the biofilm inhibition testing included: 1) cooling water bacterial population 1=total aerobic bacterial population that was obtained from cooling water samples in cooling water systems and grown on standard nutrient agar for aerobic bacteria, and 2) cooling water bacterial population 2=Pseudomonas species in cooling water systems. Pseudomonas species were collected from cooling water samples from selective media. The collected Pseudomonas population from cooling water systems were stored at −80° C. and re-inoculated into 100 mL fresh test medium (described below), incubated at a rotary shaker at 35° C., 120 ppm for 18-24 hours before used as a starter culture.

The collected aerobic bacterial populations from cooling water systems were stored at −80° C. and re-inoculated into 100 mL fresh test medium (described below), incubated at a rotary shaker at 35° C., 120 ppm for 18-24 hours before used as a starter culture.

The indication microorganisms included Pseudomonas aeruginosa ATCC 9027, Pseudomonas spp. Stock, and TVC stock.

The concentration range for the testing of these microorganisms for the waters was 10⁴-10⁸ CFU/ml.

The following Examples utilized a 96-well microtiter plate and aerobic incubation.

The Biofilm inhibition testing utilized a test medium with a final concentration of 16% test medium in the water. The test medium included 0.5% (w/w) casitone, 0.2% (w/w) yeast extracts, 1% (v/v) glycerol, and 1 ppm FeCl₃. 4X of the medium was made and used a stock medium during testing.

0.5 g of chemicals were weighed and diluted to 49.5 g of deionized water to make up a 1% stock solution.

Unless otherwise noted the water was standard 13 waterμartificial surface fresh water CaCl₂·2H₂O 0.220 g, MgSO₄·7H₂O 0.185 g, NaHCO₃ 0.185 g in 1000 mL dH₂O.

The Chemicals included Chemical A, Chemical B, Chemical C, Chemical D, Chemical E, QATS Biocide, and Alkyl Poly Glucosides.

QATS Biocide is a quaternary ammonium compound active Didecyl Dimethyl Ammonium Chloride.

Chemical A was predominantly of Pluronic P123, referred to herein as a polyoxypropylene-polyoxyethylene (EO-PO) block copolymer.

Chemical B was predominantly Pluronic P103, referred to herein as a polyoxypropylene-polyoxyethylene (EO-PO) block copolymer.

Chemical C was a non-ionic emulsifier containing C16 (EO)20 ethoxylated alcohols, referred to herein as an alkoxylated fatty alcohol.

Chemical D was a non-ionic emulsifier containing C18 (EO)20 ethoxylated alcohols, referred to herein as an alkoxylated fatty alcohol.

Chemical E was a non-ionic emulsifier containing C16-C18 (EO)25 ethoxylated alcohols, referred to herein as an alkoxylated fatty alcohol.

Sterilized deionized water was used to create the medium for lab screening and efficacy comparisons.

The dyes used included 350 ppm 2-(4-Iodophenyl)-3-(4-nitrophenyl)-5-phenyltetrazolium chloride (INT) for activity and 2,000 ppm crystal violet for matrix stain.

### EXAMPLE 1

The synergy of chemicals on bacterial biofilm inhibition in Table 1 were tested using two different chemicals, Chemical A and Chemical B. Each Chemical was tested on Cooling Water Bacterial Population 1 and Cooling Water Bacterial Population 2.

To quantify the biofilm and effect of the chemicals, the minimal biofilm eradication concentration (MBEC) using a method similar to the ASTM method for Testing disinfectant efficacy against Pseudomonas aeruginosa Biofilm using MBEC Assay (E2799-12), Standard Test Method for Testing Disinfectant Efficacy against Pseudomonas aeruginosa Biofilm using MBEC Assay.

The biofilm inhibition test was conducted utilizing the 96 well microtiter plate and static or aerobic incubation. In one experiment, the two chemicals tested included Chemical A, was applied to Cooling Water Bacteria Population 1 at various concentrations (0.78 ppm, 1.54 ppm, 3.08 ppm, and 6.25 ppm). Additionally, Chemical B, was also applied to Cooling Water Bacterial Population 1 at various concentrations (3.10, 6.30, and 12.50). The same was done using Chemicals A and B on Cooling Water Bacteria Population 2 at various concentrations as outlined in Table 1.

After applying the chemical treatments to the plate with the Bacteria Populations 1 and 2, the plate was incubated 35° C. in a humidity-controlled incubator for 48 to 60 hours. After the incubation was completed, the cultures were poured out from the plates and the crystal violet dye was then deposited in each well before incubating the plate for another 15 minutes. The 96 well microtiter plate was then washed three to four times with cold water and prepared for reading in order to record the chemical efficacy of each chemistry on the bacteria populations.

The formula used to calculate each Synergy index value was SI=Qa/QA+Qb/QB.

Qa=Concentration of A in a chemical mixture of A+B

QA=Concentration of A as a single chemical

Qb=Concentration of B in a chemical mixture of A+B

QB=Concentration of B as a single chemical

An SI index of less than 1 is Synergistic (with greater synergy the lower the number), SI index equal to 1 is additive and SI index of greater than 1 is Antagonistic.

TABLE 1

| | Chemical A | Chemical B | Synergy |
|---|---|---|---|
| Bacterial Population | (ppm) | (ppm) | Index Values |
| Cooling Water | 6.25 | 0 | 0 |
| Bacteria Population 1 | 0 | 12.50 | 0 |
| | 3.08 | 3.10 | 0.74 |
| | 1.54 | 3.10 | 0.49 |
| | 0.78 | 6.30 | 0.63 |
| Cooling Water | 3.13 | 0 | 0 |
| Bacteria Population 2 | 0 | 6.13 | 0 |
| | 1.56 | 1.60 | 0.76 |
| | 0.78 | 1.60 | 0.51 |
| | 0.77 | 3.10 | 0.75 |

The data above demonstrated that Chemical A and Chemical B (both predominantly polyoxypropylene-polyoxyethylene (EO-PO) block copolymers) in Cooling Water Bacteria Population 1 had the highest synergy index value when present in roughly equal amounts (3.08 ppm and 3.10 ppm). These results showed that the combination of block copolymers with different molecular weight ranges can also provide a synergistic combination. The lowest synergy index value was obtained when Chemical A was present at a concentration of 1.54 whereas Chemical B was present at a concentration of 3.10.

Similarly, the data revealed that in Cooling Water Bacteria Population 2, that the highest synergy index value of 0.76 was attained when Chemical A was present in the amount of 1.56 ppm and Chemical B was present in the amount of 1.6. Conversely, the lowest synergy index value (indicating greatest synergy of the combination of surfactants in inhibiting microbial growth) was found when Chemical A was present in a concentration of 0.78 ppm and Chemical B was present in the amount of 1.6 ppm.

The data therefore suggests that the highest synergy (i.e. the lowest Synergy Index value) was found when testing with Cooling Water Bacteria Population 1 when Chemical A is present at nearly half the concentration of Chemical B.

### EXAMPLE 2

Following the same procedure as outlined in Example 1, another plate was run using various concentrations of Chemical A and Chemical C, showing the impact of the combination of a polyoxyalkylene-polyoxyethylene block copolymer (A) and an alkoxylated fatty alcohol (C), on both Cooling Water Bacteria Populations 1 and 2. The concentrations of each Chemical used is outlined in Table 2.

TABLE 2

| | Chemical A | Chemical C | Synergy Index |
|---|---|---|---|
| Bacterial Population | (ppm) | (ppm) | Values |
| Cooling Water | 6.25 | 0 | 0 |
| Bacteria Population 1 | 0 | 12.50 | 0 |
| | 3.03 | 6.30 | 0.99 |
| | 1.51 | 6.30 | 0.75 |
| | 3.13 | 1.60 | 0.63 |
| Cooling Water | 3.13 | 0 | 0 |
| Bacteria Population 2 | 0 | 12.5 | 0 |
| | 1.54 | 3.10 | 0.74 |
| | 1.55 | 1.60 | 0.62 |
| | 0.78 | 1.60 | 0.38 |

The data shows that when testing Chemical A and Chemical C in Cooling Water Bacterial Population 1, the highest synergy index value of 0.99 was found when Chemical A was present in the amount of 3.03 ppm and Chemical C was present in the amount of 6.30 ppm. Given that 0.99 is nearly 1, this indicates a nearly additive relationship between the chemicals tested and Cooling Water Bacteria Population 1.

However, when Chemical A was present in the amount of 3.13 ppm and Chemical C was present in the amount of 1.60 ppm, the synergy index value was its lowest with 0.63. This indicates that when Chemical A is present in nearly twice the amount of Chemical C in Cooling Water Bacteria Population 1, there is a higher synergy between the Chemicals.

In Cooling Water Population 2, when Chemical A was present in the amount of 1.54 ppm and Chemical C was present in the amount of 3.10 ppm, the highest synergy index value was returned with 0.74 ppm. However, when Chemical A was present in the amount of 0.78 ppm and Chemical C was present in the amount of 1.60 ppm, this returned the lowest synergy index value indicating that the most amount of synergy was experienced between Chemicals A and C with Cooling Bacterial Population 2 when Chemical A was present in nearly half the amount of Chemical C.

### EXAMPLE 3

Following the same procedure as outlined in Examples 1 and 2, another plate was run using various concentrations of Chemical B (predominantly a polyoxypropylene-polyoxyethylene (EO-PO) block copolymer) and Chemical C (alkoxylated fatty alcohol) at varying concentrations on both Cooling Water Bacteria Populations 1 and 2. The concentrations of each Chemical used is outlined in Table 3.

TABLE 3

| | | Minimum | Synergy |
|---|---|---|---|
| | | Inhibition | Index |
| Bacterial Population | Chemical | Concentration | Values |
| Cooling Water | Chemical B | 6.0 | 0 |
| Bacteria Population 1 | Chemical C | 3.0 | 0 |
| | Chemical B:Chemical | 1.6:1.6 | 0.8 |
| | C 1:1 | | |
| | Chemical B:Chemical | 1.6:0.8 | 0.53 |
| | C 2:1 | | |
| | Chemical B:Chemical | 0.8:1.6 | 0.67 |
| | C 1:2 | | |
| Cooling Water | Chemical B | 12.0 | 0 |
| Bacteria Population 2 | Chemical C | 6.0 | 0 |
| | Chemical B:Chemical | 1.6:1.6 | 0.4 |
| | C 1:1 | | |
| | Chemical B:Chemical | 3.2:1.6 | 0.53 |
| | C 2:1 | | |
| | Chemical B:Chemical | 1.6:3.2 | 0.67 |
| | C 1:2 | | |

The data shows that when Chemical B, and Chemical C were tested in Cooling Water Bacteria Population 1, the highest synergy index value was found when Chemical B and Chemical C were present in a ratio of 1:1. By contrast, the lowest synergy index value indicating the highest level of synergy between Chemicals tested in Cooling Water Bacteria Population 1 was found between Chemical B and Chemical C in a ratio of 2:1.

Conversely, when tested in Cooling Water Bacteria Population 2, the opposite was found to be true, demonstrating that the synergy levels of chemical combinations can vary based on bacterial populations and changes in conditions. The lowest synergy index value indicating the highest level of synergy between Chemicals was present when Chemical B and Chemical C were present in a ratio of 1:1. Additionally, the highest synergy index value was found between Chemicals B and Chemical C when they were present in a ratio of about 1:2 polyoxypropylene-polyoxyethylene (EO-PO) block copolymer to alkoxylated fatty alcohol.

These results show a clear synergistic combination of the chemistries (synergy index value<1) where in a substantial reduction in the chemistry concentration (MIC values) can be used in comparison to the independent chemistries on their own when tested in the bacterial populations 1 and 2.

### EXAMPLE 4

In another example utilizing the same protocol, the plate was run with a control utilizing no Chemical treatment, Chemical B, Chemical A, Chemical C and a combination of Chemicals A and C on a Bacteria Population to assess the biofilm inhibition efficiency of different chemistries on the Bacteria Population 1 as previously described.

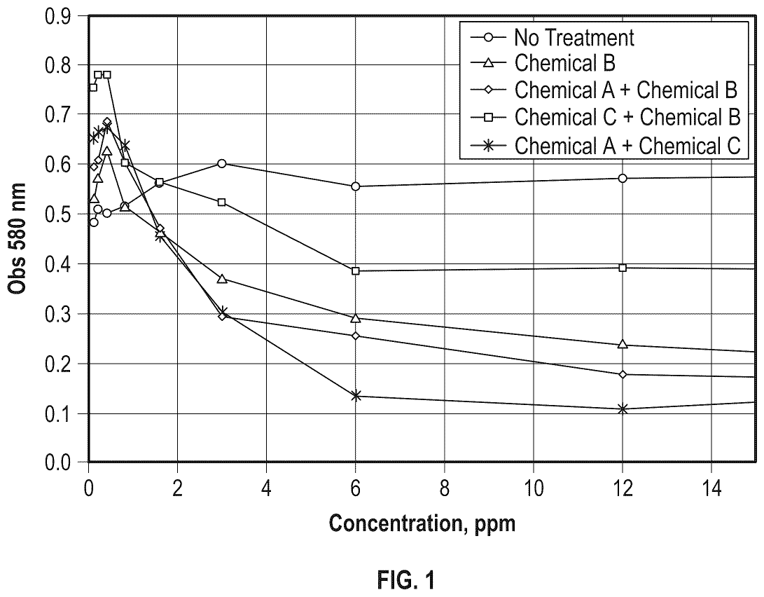

As shown in FIG. 1, the x axis indicates the concentration of each chemical present and the y axis indicates the total quantity of biofilm build up present. The control where there was no chemical treatment present indicated a steady presence of biofilm build up between absorbance 0.5 to 0.6. The biofilm concentrations are correlated to the absorbance at wavelength 580-595 nm (depicted in figures as Obs 580 nm). The higher absorbance value indicates a greater amount of biofilm built up on the walls of the reactor (well). Crystal violet (CV) is widely used for biomass staining and quantification in all sectors of research. Obs 580 was used to determine the quantity of CV in the extracts proportionally related to biomass quantity as described in ASTM E2799-12 Standard test method for testing disinfectant efficacy against Pseudomonas aeruginosa biofilm using the MBEC assay; Steponovic S. et al. 2000. A modified microtiter-plate test for quantification of staphylococcal biofilm formation. J of Microbiological Methods 40:175-179; Wilson, C et al. 2018. Quantitative and Qualitative Assessment Methods for biofilm Growth: A Mini-review. PMC 17-20.

The combination of Chemical A and C resulted in the lowest amount of biofilm build up when the concentration of Chemical A and C increases past 3 ppm, with a steadily decreasing biofilm buildup of 0.3, down to 0.1. Conversely, Chemical C showed the highest biofilm build up when present at a concentration of nearly 1 ppm present with a biofilm buildup of nearly 0.8 with the steady decrease to 0.4. This was noticeably higher than the other chemical treatments tested, indicating that the combination of Chemicals A and C were the most effective in reducing the quantity of biofilm buildup.

### EXAMPLE 5

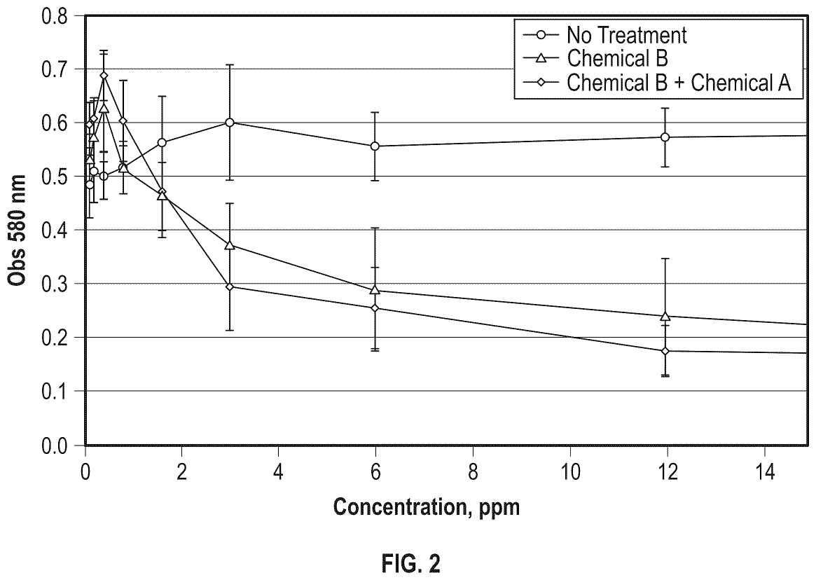

Using the same protocols as previously described additional experimentation was conducted where another plate was run with a control utilizing no Chemical treatment, Chemical B, and a combination of Chemicals B and A on a Bacteria Population to assess the biofilm inhibition efficiency of different chemistries on the Bacteria Population 1. As shown in data in FIG. 2, the x axis indicates the concentration of each chemical present and the y axis indicates the total quantity of biofilm build up present. The control where there was no chemical treatment present indicated a steady presence of biofilm build up between 0.5 to 0.6.

Chemical B indicated an initial increase in biofilm from 0.5 to 0.62 when Chemical B was present in a concentration from 0 to 1 ppm, and a sharp decline in biofilm build up down to nearly 0.2 as the concentration of Chemical B increased. In a surprising discovery, the combination of Chemical B and Chemical A dramatically reduced the presence of biofilm build up when the combination of chemistries were present in over 1 ppm. Therefore, the data suggests that this combination was the most effective in reducing biofilm buildup. Again these results showed that the combination of block copolymers with different molecular weight ranges can also provide a synergistic combination.

### EXAMPLE 6

Another plate was run according to the same procedures outlined in Examples 1-3. The experiment tested Chemicals including Alkyl Poly Glucoside, QAT Biocide, Chemical B, Chemical A+D for Planktonic inhibition as well as Biofilm Inhibition as reflected in Table 4.

TABLE 4

| | ppm | | | | | |
|---|---|---|---|---|---|---|
| | Planktonic | Planktonic | Total Biofilm | Total Biofilm | Biofilm | Biofilm |
| | Inhibition | Inhibition | Inhibition | Inhibition | Reduction | reduction |
| Chemistry | Bact P1 | Bact P2 | Bact P1 | Bact P2 | Bact P1 | Bact P2 |
| QATS Biocide | 3 | 1.6 | 6 | 1.6 | 0.8 | 0.8 |
| Alkyl Poly | >1000 | >1000 | >1000 | >1000 | >1000 | >1000 |
| Glucosides | | | | | | |
| Chemical B | >1000 | >1000 | 6 | 12 | 0.8 | 0.8 |
| Chemical A + | >1000 | >1000 | 1.6-6 | 6-12 | 0.8 | 0.8 |
| Chemical D | | | | | | |

The results in Table 4 show minimum biofilm inhibition concentrations (ppm) when treating different bacterial populations with each of the chemicals alone. The results show there was no planktonic bacterial growth inhibition for any of the chemicals except the QATS that effectively killed bacterial with 3 ppm or less. The QATS inhibit both planktonic and sessile bacterial growth at the demonstrated concentrations with different bacterial populations, while Chemicals B, A/D and the alkyl polyglycosides are non-toxic to bacterial planktonic growths, showing the high minimum inhibitory concentration (MIC), although they do effectively inhibit sessile bacterial growth, namely they can inhibit biofilm formation at different concentrations with different efficiencies.

These results show that biofilm inhibition (or the prevention of biofilm growth) at the listed concentration varies amount the chemistries. The results further show that biofilm reduction (or the reduction of the biofilm) at the listed concentration varies amount the chemistries as well. These variations are indicative of the state of the art in that it was not expected that the combination of Chemicals would provide efficacy in inhibiting biofilm formation.

### EXAMPLE 7

Additional testing was run to show various evaluated concentrations of chemistries including No Treatment (Control), QAT Biocide, Chemical B, and Chemical A+E for assessing biofilm reduction based on average planktonic bacterial concentrations as shown in Table 5.

The following methodology for the bacterial concentration in liquid culture were used:

Plate count: plate the treated bacterial mixture after serial dilutions with required mediums like R2A, Petrifilms etc.

Minimum Inhibition Concentration (MIC): at this concentration, bacterial population stopped growth under the above incubation conditions

OD600 turbidity: bacterial concentration is correlated with the medium turbidity, The planktonic concentration can be calculated using a turbidity to bacterial count concentration model. If OD600 is <0.1, it is considered bacterial counts <10³ cfu/ml.

The following methodology for the biofilm concentration on surface were used:

Biofilm quantity: biofilm quantity grew on surface can be determined by crystal violate staining, followed by 3 times of washing and then eluting.

Minimum biofilm inhibition concentration for total biofilm inhibition: the concentration that non-visual biofilm growth—no blue color on surfaces after crystal violet (CV) staining.

TABLE 5

| | | Avg | |
|---|---|---|---|
| | | Planktonic | |
| | | Bacterial | Avg Biofilm |
| | Concentration | Conc | Reduction |
| Chemistry | (ppm) | (Log cfu/ml) | (%) |
| Control | 0 | 8.7 | 0 |
| Quat Biocide | 1.6 | 8.672 | 49.9 |
| | 3.1 | 8.688 | 54.0 |
| | 6.2 | 8.609 | 108.4 |
| | 12.5 | 8.492 | −3.5 |
| | 25.0 | 8.590 | 34.7 |
| | 50.0 | <3.000 | −89.1 |
| | 100.0 | <3.000 | −12.1 |
| Chemistry B | 1.6 | 8.693 | 0.0 |
| | 3.1 | 8.693 | −5.1 |
| | 6.2 | 8.693 | −9.4 |
| | 12.5 | 8.695 | −7.8 |
| | 25.0 | 8.719 | −10.6 |
| | 50.0 | 8.666 | 0.7 |
| | 100.0 | 8.670 | −10.3 |
| Chemistry A + | 1.6 | 8.709 | −26.6 |
| Chemistry E | 3.1 | 8.712 | −34.0 |
| | 6.2 | 8.753 | −48.3 |
| | 12.5 | 8.727 | −52.7 |
| | 25.0 | 8.712 | −55.3 |
| | 50.0 | 8.703 | −39.6 |
| | 100.0 | 8.704 | −43.0 |

Biofilm Reduction from chemical treatment is calculated by the following: (average Treatment OD₅₉₅-average Control OD₅₉₅)*100/average Control OD₅₉₅ where the CV absorbance range used was 580-595 nm. If OD₅₉₅ was <0.1, it was considered as non-biofilm formation. CV absorbance range 580-595 nm was used in different tests.

As shown in the TABLE 5, Quat biocide showed both planktonic and biofilm control at concentration greater than 50 ppm, but effect varies when concentration is below 50 ppm. Chemistry treatments showed no effect on planktonic growth but limited biofilm reduction in all treatments of 1-100 ppm range. The Chemistry A+E showed no effects on planktonic growth but 55.3% biofilm reduction at 25 ppm treatment. Those results indicated different efficacy of chemical bacterial cell interactions with different models.

### EXAMPLE 8

Additional testing was completed to show the benefit of reducing a biocidal dose with the method of preventing biofilms described herein. Various commercial cooling water sources were evaluated for the MIC of hypochlorite (Minimum Inhibition Concentration as free chlorine for biofilm formation) as the biocide dosed with the Chemistry A+Chemistry E. The test conditions and results are shown in Table 6.

TABLE 6

| | | MIC | |
|---|---|---|---|
| | | hypochlorite | |
| | | (ppm) | |
| | MIC | With 6 ppm | Hypochlorite |
| Cooling Water | hypochlorite | Chemistry A + | Dose |
| Source | (ppm) | Chemistry E | Reduction |
| 1 | 25 | 3.1 | 87.6 |
| 2 | 25 | 6.3 | 74.8 |
| 3 | 12.5 | 0.8 | 93.6 |
| 4 | 25 | 12.5 | 50 |

The results show that the use of the Chemistry A+E according to the methods described herein beneficially reduces the biocide dosing requirement by at least about 50% across various cooling water sources having indigenous microbial populations. Under certain conditions the biocide dosing requirement was reduced by over 90%.

The Examples described herein show that the microbial interactive compositions (MIC) are not antimicrobial compositions. The MIC are non/low toxicity to microbial populations as shown in the various Tables in the Examples. They do not reduce the planktonic bacterial population density in terms of log cfu/ml as a biocidal composition does. Instead, the MIC prevent growth on surfaces that would form biofilms (i.e. inhibits biofilm).

It is to be understood that while the invention has been described in conjunction with the detailed description thereof, the foregoing description is intended to illustrate, and not limit the scope of the invention, which is defined by the scope of the appended claims. Other embodiments, advantages, and modifications are within the scope of the following claims. Any reference to accompanying drawings which form a part hereof, are shown, by way of illustration only. It is understood that other embodiments may be utilized, and structural changes may be made without departing from the scope of the present disclosure.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

What is claimed is:

1. A method for preventing biofilm formation in a process water system comprising:
contacting a process water contaminated with microbial populations in a planktonic stage and in need of biofilm prevention with an effective amount from about 1 ppm to about 1000 ppm of a microbial interactive composition to form a treated process water, wherein the microbial interactive composition comprises a combination of a polyoxypropylene-polyoxyethylene block copolymer and an alkoxylated fatty alcohol;
maintaining the microbial population in the planktonic stage in the treated process water and reducing or inhibiting biofilm formation in the process water system.

2. The method of claim 1, wherein the polyoxypropylene-polyoxyethylene block copolymer and the alkoxylated fatty alcohol have a synergistic index value between about 0.3 and about 0.9 as measured by Qa/QA+Qb/QB, wherein Qa is the concentration of A in a chemical mixture of A+B, QA is the concentration of A as a single chemical, Qb is the concentration of B in a chemical mixture of A+B, and QB is the concentration of B as a single chemical.

3. The method of claim 1, wherein the polyoxypropylene-polyoxyethylene block copolymer has the general structure of 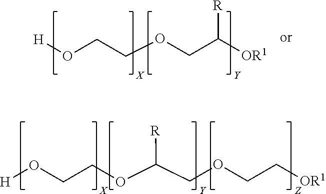
wherein:
R is CH3 or C1-C20 group;
R1 is C1-C5 group or hydrogen;
x is 5 to 100;
y is 5 to 200; and
z is 5 to 100.

4. The method of claim 3, wherein the polyoxypropylene-polyoxyethylene block copolymer is a triblock copolymer comprising poly(ethylene oxide) (PEO)-poly(propylene oxide) (PPO)-poly(ethylene oxide) (PEO) and having the general structure 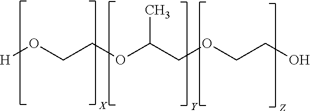
wherein x is 10 to 40; y is 50 to 100; and z is 10 to 40.

5. The method of claim 1, wherein the alkoxylated fatty alcohol has the general structure of 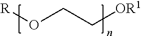
wherein R is a linear or branched, saturated or unsaturated hydrocarbon group having a carbon chain of C5-C60, C10-C20, or C5-C20, R1 is a C1-C5 saturated or unsaturated hydrocarbon group or hydrogen; and n is 1-100.

6. The method of claim 5, wherein the alkoxylated fatty alcohol has R that is a C16-C18 linear or branched hydrocarbon group and n is 10-60, 10-30, 20-30, or 20-25.

7. The method of claim 1, wherein the polyoxypropylene-polyoxyethylene block copolymer has the general structure of 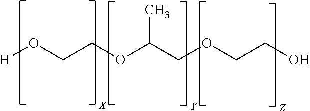
wherein x is 10 to 30; y is 50 to 100; and z is 10 to 30, and wherein the alkoxylated fatty alcohol has the general structure of 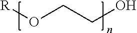
wherein R is a linear or branched, saturated or unsaturated hydrocarbon group having a carbon chain of C10-C20; and n is 20-25.

8. The method of claim 1, wherein the weight ratio of the polyoxypropylene-polyoxyethylene block copolymer to the alkoxylated fatty alcohol is about 1:1, or from about 3:1 to about 1:3.

9. The method of claim 1, wherein the microbial interactive composition further comprises at least one of a carrier, a corrosion inhibitor, an additional fouling control agent, preservative, a pH modifier, a coagulant, a flocculant, a water clarifier, a dispersant, foaming agent, antifoaming agent, or mixture thereof, and preferably wherein the carrier is water, an organic solvent or a mixture thereof.

10. The method of claim 1, wherein the microbial interactive composition comprises from about 1 wt-% to about 20 wt-% polyoxypropylene-polyoxyethylene block copolymer and from about 0.1 wt-% to about 20 wt-% alkoxylated fatty alcohol.

11. The method of claim 1, wherein the microbial interactive composition is provided in the treated process water at a concentration from about 1 ppm to about 20 ppm.

12. The method of claim 1, further comprising contacting the treated process water with a biocide to kill the microbial populations in the planktonic stage.

13. The method of claim 12, wherein the biocide comprises a quaternary ammonium compound (preferably a quaternary ammonium halide), chlorine, hypochlorite, ClO₂, bromine, ozone, hydrogen peroxide, peracetic acid, peroxycarboxylic acid, peroxycarboxylic acid composition, peroxysulphate, glutaraldehyde, dibromonitrilopropionamide, isothiazolone, terbutylazine, polymeric biguanide, methylene bisthiocyanate, or tetrakis hydroxymethyl phosphonium sulphate.

14. The method of claim 1, wherein a reduced concentration of biocide of at least about 50%, 75%, 80%, 90%, or more is required for biofilm prevention and/or remediation compared to a process water that is not treated with the microbial interactive composition, wherein the reduced concentration of biocide is dependent on conditions and systems of the process water.

15. The method of claim 14, wherein the method further comprises discharging the treated process water and wherein the discharged treated process water has reduced biocide concentration.

16. The method of claim 13, wherein the biocide is combined with an advanced oxidative process comprising one or more ozone, ultraviolet, hydrogen peroxide, and/or catalyst.

17. The method of claim 1, wherein the process water is part of an industrial water or liquid system, and/or wherein the industrial water or liquid system comprises cooling water systems, cooling liquid systems, open or closed loop water or liquid cooling systems, boilers and boiler water systems, flotation and benefaction systems, aqueous systems in papermaking processes, pulp and paper mill systems, paper mill digesters, washers, bleach plants, stock chests, white water systems, black liquor evaporators in the pulp industry, gas scrubbers and air washers, continuous casting processes in the metallurgical industry, air conditioning and refrigeration systems, indirect contact cooling and heating water, water reclamation systems, water purification systems, membrane filtration water systems, food and/or beverage processing systems and streams, brewery pasteurizers, sweat water systems, waste treatment systems, clarifiers, liquid-solid applications, industrial lubricant systems, heat transfer systems, municipal sewage treatment, municipal water systems, potable water systems, aquifers, water tanks, sprinkler systems, water heaters, textile process systems, or a combination thereof.

18. The method of claim 17, wherein the cooling water or liquid system is an open recirculating water system, closed water system, once-through cooling water system, closed loop cooling system, or direct to chip liquid cooling system.

19. The method of claim 1, wherein the microbial population is present in the process water at a concentration from about 10⁴-10¹⁰ CFU/mL.

20. The method of claim 19, wherein the microbial population comprises anaerobic and/or aerobic bacterial population to provide a biofilm forming bacterial population, and/or wherein the treated process water contacts a surface contaminated with a biofilm and/or biofilm forming bacterial population, and/or wherein the surface is partially or fully submerged in the treated process water.

21. The method of claim 20, wherein the treated process water achieves microbial kill.
